(19) United States
(12) Patent Application Publication
(10) Pub. No.: US 2025/0349831 A1
(43) Pub. Date: Nov. 13, 2025

(54) LITHIUM-ION POUCH CELL WITH A WIDE TEMPERATURE RANGE AND HIGH SAFETY AND PREPARATION METHOD THEREOF

(71) Applicant: Wuhan University of Science and Technology, Wuhan (CN)

(72) Inventors: Kaifu Huo, Wuhan (CN); Biao Gao, Wuhan (CN); Fengrui Liu, Wuhan (CN); Xiangsheng Dong, Wuhan (CN)

(73) Assignee: Wuhan University of Science and Technology, Wuhan (CN)

(21) Appl. No.: 19/278,739

(22) Filed: Jul. 23, 2025

(30) Foreign Application Priority Data
Jul. 25, 2024 (CN) 202411005887.3

(51) Int. Cl. H01M 4/36; H01M 4/02; H01M 4/04; H01M 4/58; H01M 10/0525; H01M 10/44; H01M 50/105; H01M 50/414; H01M 50/44

(52) U.S. Cl. CPC H01M 4/364; H01M 4/0416; H01M 4/0435; H01M 4/5825; H01M 10/0525; H01M 10/446; H01M 50/105; H01M 50/414; H01M 50/44; H01M 2004/027; H01M 2004/028

(57) ABSTRACT

The pouch cell includes a positive electrode, a negative electrode, and a diaphragm placed between the positive electrode and the negative electrode. The positive electrode material includes a ternary material coated with lithium manganese iron phosphate; the negative electrode material includes a silicon carbon-mesophase carbon microsphere composite material; the diaphragm is a polyimide nanofiber diaphragm. The present disclosure uses silicon carbon-mesophase carbon microsphere composite material as the negative electrode, lithium manganese iron phosphate coated ternary positive electrode as the positive electrode material, and polyimide nanofiber separator. The safety is obviously improved during piercing. Meanwhile, it may take into account the electrical performance, improve the capacity, charge and discharge rate, long cycle performance and wide temperature range performance of lithium-ion cells; it also improves the service life and cycle life; it has low calorific value, good safety, high stability, and is not prone to dangerous situations such as combustion or explosion.

### TECHNICAL FIELD

The present disclosure belongs to the technical field of lithium-ion cells, especially relates to a lithium-ion pouch cell with a wide temperature range and high safety and a preparation method thereof.

### BACKGROUND

Lithium-ion cells are important energy storage devices widely used in portable electronic devices, electric vehicles, and energy storage systems. Among them, negative electrode materials play a vital role in cell performance and cycle life. In order to improve the energy density, cycle stability, and charge-discharge rate of lithium-ion cells, researchers have been working on developing negative electrode pastes with high capacity and high rate. The materials of existing pouch cells including lithium cobalt oxide+graphite; nickel cobalt lithium manganate+graphite; lithium manganate+graphite, etc., are insufficient to meet the application requirements of large capacity, wide temperature range, and high safety. Therefore, in view of the above technical problems, it is necessary to provide a lithium-ion pouch cell with a wide temperature range and high safety.

### SUMMARY

In view of the shortcomings of the above existing technologies, the present disclosure provides a lithium-ion pouch cell with a wide temperature range and high safety and a preparation method thereof, wherein the specific technical scheme is as follows:

The first purpose of the present disclosure is to provide a lithium-ion pouch cell with a wide temperature range and high safety, wherein the cell includes a positive electrode, a negative electrode, and a diaphragm placed between the positive and negative electrodes.

A positive electrode material includes a ternary material coated with lithium manganese iron phosphate;
a negative electrode material includes a silicon carbon-mesophase carbon microsphere composite material;
the diaphragm is a polyimide nanofiber diaphragm.

The present disclosure may improve the capacity and long cycle performance of lithium-ion cells by using silicon carbon-mesophase carbon microsphere composite material as a negative electrode. The present disclosure uses a ternary positive electrode coated with lithium manganese iron phosphate as a positive electrode material. Due to the addition of lithium manganese iron phosphate, the lithium manganese iron phosphate cell is the same as the traditional lithium iron phosphate cell in structure at a very low temperature. The use of a ternary positive electrode coated with lithium manganese iron phosphate as a positive electrode material not only has high energy density but also improves safety performance. The present disclosure adopts a polyimide (PI) nanofiber separator, which may improve the charge-discharge rate of the cell. The PI diaphragm may withstand high temperatures above 250° C. When piercing the diaphragm, the local overheating caused by the micro-short circuit or small area short circuit of the cell will not melt the PI diaphragm and cause the perforation area to continue to expand, that is, it will not cause the short circuit area to continue to expand and the temperature to be out of control, thereby avoiding cell explosion and fire. The cell using the above-mentioned cell material may significantly improve the safety during piercing, and may also take into account the electrical performance.

In some embodiments, the silicon carbon-mesophase carbon microsphere composite is porous silicon filled with hard carbon-coated mesophase carbon microspheres.

The present disclosure is a lithium-ion cell made of porous silicon filled with hard carbon-coated mesophase carbon microspheres as the negative electrode. During the cycle, the mesophase carbon microspheres may alleviate the volume expansion of the silicon negative electrode. The hard carbon coating layer may reduce the side reaction between the silicon negative electrode and the electrolyte and form a stable solid electrolyte interface layer, which significantly improves the performance of the porous silicon negative electrode material, thereby improving the capacity and long cycle performance of the lithium-ion cell. Under high and low temperature conditions, silicon and hard carbon may provide excellent high and low temperature electrochemical performance, thereby improving the wide temperature range performance of lithium-ion cells.

In some embodiments, a preparation method for a negative pole piece, including the following steps:
Step A1, performing a sol process for sodium carboxymethyl cellulose and deionized water, a mass ratio of the sodium carboxymethyl cellulose to deionized water is 3:(95-100), high-speed stirring for 1-3 hours to configure a first glue, a stirring speed is 30 RPM in revolution and 1300 RPM in rotation;
Step A2, adding a conductive agent to the above-prepared first glue, and performing a high-speed stirring for 1-2 hours to prepare a second glue, a stirring speed is 35 RPM in revolution and 3500 RPM in rotation;
Step A3, adding the silicon carbon-mesocarbon microsphere composite material and graphite with a mass ratio of (20-30):75 to the second glue, vacuum stirring for 2-3 hours, a vacuum degree is −85 KPa, a stirring speed is 42 RPM in revolution and 4500 RPM in rotation, configuring a first mixture;
Step A4, adding a water-based binder to the above first mixture, and slowly stirring for 0.5-1 hours to obtain a second mixture, a stirring speed is 30 RPM in revolution and 1300 RPM in rotation;
Step A5, testing by a viscometer and adjusting a viscosity of the second mixture, a viscosity range is 1500-5000 MPa·S, and then filtering through a 200-mesh sieve to obtain a negative slurry;
Step A6, after the electrode slurry is evenly coated on a surface of 6 μm PET composite copper foil through a coating device, a coating thickness is 130-150 μm, and drying the electrode to form a pole piece;
Step A7, rolling and slicing the pole piece, the roll thickness is 90-110 μm, a width of the pole piece is 72-73 mm, obtaining a negative pole piece.

In some embodiments, the conductive agent includes SuperP-Li, Ketjen black, CNT, conductive carbon black, etc.

In some embodiments, the water-based binder is a mixed solution of styrene-butadiene (SBR) emulsion and water-based polybenzoate (PAA) emulsion; a mass ratio of styrene-butadiene (SBR) emulsion and water-based polyacrylate (PAA) emulsion is 1:1.

In some embodiments, the preparation method for the positive pole piece includes the following steps:
Step B1, stirring the ternary positive electrode material coated with lithium manganese iron phosphate and oily binder polyvinylidene fluoride (PVDF) with a mass ratio of (93-99):2 evenly to obtain a positive electrode slurry;
Step B2, coating the positive electrode slurry on a surface of 10 μm PET composite aluminum foil, rolling and slicing to obtain a positive pole piece, a coating thickness is 120-150 μm, a rolling thickness is 90-120 μm, and a width of the slice is 69-70 mm.

The second purpose of the present disclosure is to provide a preparation method for the above lithium-ion pouch cell with a wide temperature range and high safety. The preparation steps are as follows:
Step C1, winding the positive pole piece, the negative pole piece, and the polyimide nanofiber separator into a cell, and covering and pasting the core with a finishing glue;
Step C2, performing a pole ear welding the positive pole piece and the negative pole piece, a length of a welding end of the pole ear welding is 12-20 mm, and a thickness of a weld toe glue of the pole ear welding is 16 μm-30 μm;
Step C3, assembling with an aluminum-plastic film of a pre-punched pit, and performing a top sealing and a side sealing to form an unfilled pouch cell;
Step C4, injecting electrolyte into an unfilled pouch cell to form a liquid-filled pouch cell;
Step C5, performing a standing treatment for the liquid-filled pouch cell, after the electrolyte is fully infiltrated, forming, and then the formed cell is subjected to exhaust treatment and sealing to form a pouch cell.
Step C6, forming process.

The forming process is to use the constant power charging method to make the full cell in a high current state when the charging acceptance ability is high, and in a relatively low current state when the charging acceptance ability is low, so as to improve the current utilization rate and the first charge and discharge efficiency of the cell.

In some embodiments, the forming process includes an activation constant-current stage, a low-voltage constant-current charging stage, and a constant-voltage charging stage.

The activation constant-current stage, configured to detect whether the cell state is normal and initially activate the cell to charge to 3.0 V at 0.02 C;
the low-voltage constant-current charging stage, configured to open and enrich a lithium-ion channel in the electrodes and separator, so as to facilitate a subsequent rapid charging to a cell terminal voltage of 3.45-3.65V at 0.05 C;
the constant voltage charging stage, configured to promote q conversion of active substances in a deep layer of the electrode, and the cell formation is completed when the constant voltage is 4.0V to 0.1 C.

The beneficial effects of the present disclosure are as follows:

The present disclosure uses silicon carbon-mesophase carbon microsphere composite material as the negative electrode, lithium manganese iron phosphate coated ternary positive electrode as the positive electrode material, and polyimide nanofiber separator. The cell exhibits excellent safety, wide temperature range characteristics, and long cycle life.

### BRIEF DESCRIPTION OF THE DRAWINGS

FIG. 1 is a charge-discharge curve of the pouch cell prepared by Example 1 of the present disclosure under the condition of −50° C. and ultra-high current density.

FIG. 2 is a long cycle performance diagram of the pouch cell prepared by Example 1 of the present disclosure under the condition of −50° C. and ultra-high current density.

### DETAILED DESCRIPTION OF THE EMBODIMENTS

The following describes the principles and characteristics of the present disclosure with examples. The examples are only configured to explain the present disclosure, not to limit the scope of the present disclosure.

### Example 1

A preparation method for lithium-ion pouch cells with a wide temperature range and high safety includes the following steps:

### 1. Preparation of Negative Pole Piece

Step A1, a sol process was performed for sodium carboxymethyl cellulose and deionized water, the mass ratio of the sodium carboxymethyl cellulose to deionized water was 3:97, high-speed stirred for 2 hours to configure the first glue, the stirring speed was 30 RPM in revolution and 1300 RPM in rotation;
Step A2, a conductive agent, namely carbon black, was added to the above-prepared first glue, and high-speed stirring was performed for 1-2 hours to prepare the second glue, the stirring speed was 35 RPM in revolution and 3500 RPM in rotation;
Step A3, the silicon carbon-mesocarbon microsphere composite material and graphite with a mass ratio of 25:75 were added to the second glue, vacuum stirring was performed for 3 hours (the vacuum degree was −85 KPa), the stirring speed was 42 RPM in revolution and 4500 RPM in rotation, the first mixture was configured;
Step A4, a water-based binder (2% of the total solid matter) was added to the above first mixture, and slowly stirred for 1 hour to obtain a second mixture, the stirring speed was 30 RPM in revolution and 1300 RPM in rotation; the water-based binder was a mixed solution of styrene-butadiene (SBR) emulsion and water-based polybenzoate (PAA) emulsion, and the mass ratio of styrene-butadiene (SBR) emulsion to water-based polybenzoate (PAA) emulsion was 1:1.
Step A5, the second mixture was tested by a viscometer, and the viscosity was adjusted, the viscosity range was 1500-5000 MPa·S, and then filtered through a 200-mesh sieve to obtain a negative slurry;
Step A6, after the electrode slurry was evenly coated on the surface of 6 μm PET composite copper foil through a coating device, the coating thickness was 130-150 μm, and the electrode was dried to form a pole piece;
Step A7, the pole piece was rolled and sliced, a negative pole piece was obtained, the roll thickness was 90-110 μm, the width of the pole piece was 72-73 mm, the negative pole piece was obtained.

### 2. Preparation of Positive Pole Piece

Step B1, the positive electrode slurry was obtained by stirring the ternary positive electrode material coated with lithium manganese iron phosphate and the oily binder (polyvinylidene fluoride, PVDF) evenly.
Step B2, the positive electrode slurry was coated on the surface of 10 μm PET composite aluminum foil, rolled, and sliced to obtain the positive pole piece. The coating thickness was 120-150 μm, the rolling thickness was 90-120 μm, and the slice width was 69-70 mm.

### 3. Preparation of Pouch Cell

Step C1, the positive pole piece, the negative pole piece, and the polyimide nanofiber separator were wound into a cell, and the core was covered and pasted with the finishing glue;
Step C2, the positive pole piece and the negative pole piece were welded by the tab. The length of the welding end of the tab welding was 15 mm, and the thickness of the weld toe glue of the tab welding was 20 μm;
Step C3, it was assembled with the aluminum-plastic film of the pre-punched pit, and top sealing and side sealing were performed to form an unfilled pouch cell.
Cell tank: The thickness of the aluminum plastic film was 150 μm, and the cell tank adopted a single-sided punching pit. There was no side at the bottom of the cell, and the pit shape with one side opening was formed by pressing. The cell tank was divided into a tank area and an air bag area, the tank area was configured to place the cell, and the air bag area was configured to hold the gas generated during the formation of the cell.
Cell cover: An aluminum-plastic film with the same specifications and materials as the cell was adopted. The cell cover was a planar structure, and the size of the cell cover was the same as the projection size of the cell plane.
Step C4, quantitative (2.5 g/Ah) electrolyte (the main components are 1.15 M LiPF6, PS, FEC, EC, PC, DMC, DEC) was injected into the unfilled pouch cell to form a liquid-filled pouch cell;
Step C5, a standing treatment was performed for the liquid-filled pouch cell, after the electrolyte was fully infiltrated, it was formed, and then the formed cell was subjected to exhaust treatment and sealing to form a pouch cell;
Step C6, the forming process included an activation constant-current stage, a low-voltage constant-current charging stage, and a constant voltage charging stage;
the activation constant-current stage was configured to detect whether the cell state is normal and initially activated the cell to charge to 3.0 V at 0.02 C;
the low-voltage constant-current charging stage was configured to open and enrich the lithium-ion channel in the electrode and separator, so as to facilitate the subsequent rapid charging of 0.05 C to the cell terminal voltage of 3.45-3.65 V;
the constant voltage charging stage was configured to promote the conversion of active substances in the deep layer of the electrode, and the cell formation was completed when the constant voltage was 4.0V to 0.1 C.

### Test Procedure:

The capacity dividing process is as follows: The cell was charged at 0.25° C. to 4.2 V for 5 minutes and then discharged at 0.25° C. to 2.75 V, after 2000 cycles at 1 C current, the capacity retention rate was greater than or equal to 80%.

Low temperature discharge process: after charging at 1 C to 4.2V at room temperature (at −50-50° C.), standing was performed for 16 h and then discharged (1-3 C) to 2.5V.

Low temperature charge and discharge cycle process: after 16 h at low temperature (−50° C.), it was charged to 4.2V at 0.1 C and stood for 5 min, then discharged to 2.5V at 0.5 C after 1000 cycles, the capacity retention rate is greater than or equal to 80%.

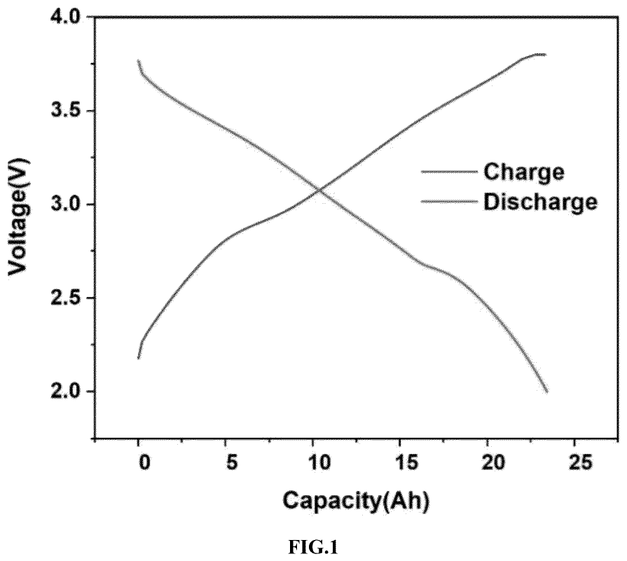

FIG. 1 is a charge-discharge curve of the pouch cell prepared for this example under the condition of −50° C. at ultra-large current density; as shown in FIG. 1, the pouch cell prepared in this example works normally under the condition of −50° C. at a large current density, and works normally at low temperature.

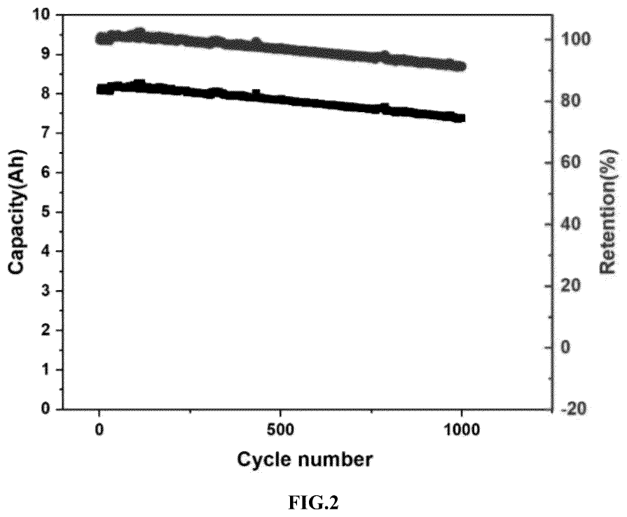

FIG. 2 is a long cycle performance diagram of the pouch cell prepared for this example under the condition of −50° C. at ultra-high current density. As shown in FIG. 2, the capacity retention rate of the pouch cell prepared by this example is more than 80% after 1000 cycles at −50° C., and the low-temperature long-cycle performance is excellent.

The puncture test of the pouch cell prepared by Example 1 of the present disclosure shows that the extremely low temperature rise after piercing, no smoke, no explosion, the highest temperature on the surface of the cell is 53° C., and the voltage may still be maintained for 8-10 hours and then reduced to below 2.0 V.

In this example, a lithium-ion pouch cell with a wide temperature range and high safety is prepared. The porous silicon filled with hard carbon-coated mesophase carbon microspheres is used as the negative electrode material, and other components, such as water-based binders, are configured to improve the compatibility of the electrolyte and the negative electrode material. The performance of the cell is further improved, and the discharge capacity of the cell is effectively improved. During the cycle, the mesophase carbon microspheres may alleviate the volume expansion of the silicon negative electrode, and the hard carbon coating layer may reduce the side reaction between the silicon negative electrode and the electrolyte and form a stable solid electrolyte interface layer. Significantly improve the performance of porous silicon negative electrode materials, thereby improving the capacity and long cycle performance of lithium-ion cells. Under high and low temperature conditions, silicon and hard carbon may provide excellent high and low temperature electrochemical performance, thereby improving the wide temperature range performance of lithium-ion cells.

The ternary positive electrode and lithium manganese iron phosphate are used as positive electrode materials. Due to the addition of lithium manganese iron phosphate, the capacity retention rate of lithium manganese iron phosphate may reach about 75% at a very low temperature. The lithium manganese iron phosphate cell has the same structure as the traditional lithium iron phosphate cell, and the composition of the positive electrode material is also similar. Therefore, it also has high stability and is not prone to dangerous situations such as combustion or explosion, which improves the safety performance. That is, the use of lithium manganese iron phosphate-coated ternary positive electrode as a positive electrode material not only has high energy density but also improves safety performance.

The use of polyimide nanofiber separator may improve the charge-discharge rate of the cell. Long service life, improved cycle count; low calorific value, good safety may also result. Additionally, the PI diaphragm may withstand high temperatures above 250° C. When piercing the diaphragm, local overheating caused by the micro-short circuit or small area short circuit of the cell will not melt the PI diaphragm. That is, as the perforation area continues to expand, it will not cause the short circuit area to continue to expand and result in thermal runaway.

The test results show that the combination of the three materials ensures that the cell has high and low temperature electrochemical and safety performance, and the safety is significantly improved during piercing. At the same time, the electrical performance of the cells meets the needs of most applications of pouch cells.

The above is only a specific embodiment of the present disclosure and is not to be interpreted as restricting the scope of the present disclosure. Any modification, equivalent replacement, improvement, etc., made within the spirit and principle of the present disclosure shall be included in the protection scope of the present disclosure.

What is claimed is:

1. A lithium-ion pouch cell with a wide temperature range and high safety, comprising a positive electrode, a negative electrode, and a diaphragm placed between the positive and negative electrodes;
a positive electrode material comprising a ternary material coated with lithium manganese iron phosphate;
a negative electrode material comprising a silicon carbon-mesophase carbon microsphere composite material;
wherein the diaphragm is a polyimide nanofiber diaphragm.

2. The lithium-ion pouch cell with a wide temperature range and high safety according to claim 1, wherein the silicon carbon-mesophase carbon microsphere composite is porous silicon filled with hard carbon-coated mesophase carbon microspheres.

3. The lithium-ion pouch cell with a wide temperature range and high safety according to claim 1, wherein a method for preparing a negative pole piece comprises:
Step A1, performing a sol process for sodium carboxymethyl cellulose and deionized water, wherein a mass ratio of the sodium carboxymethyl cellulose to deionized water is 3:(95-100), performing a high-speed stirring for 1-3 hours to configure a first glue, wherein a stirring speed is 30 RPM in revolution and 1300 RPM in rotation;
Step A2, adding a conductive agent to the above-prepared first glue, and performing a high-speed stirring for 1-2 hours to prepare a second glue, wherein a stirring speed is 35 RPM in revolution and 3500 RPM in rotation;
Step A3, mixing the silicon carbon-mesocarbon microsphere composite material and graphite with a mass ratio of (20-30):75 to the second glue, vacuum stirring for 2-3 hours, wherein a vacuum degree is −85 KPa, a stirring speed is 42 RPM in revolution and 4500 RPM in rotation, forming a first mixture;
Step A4, adding a water-based binder to the above first mixture, and slowly stirring for 0.5-1 hours to obtain a second mixture, wherein a stirring speed is 30 RPM in revolution and 1300 RPM in rotation;
Step A5, testing by a viscometer and adjusting a viscosity of the second mixture, wherein a viscosity range is 1500-5000 MPa·S, and then filtering through a 200-mesh sieve to obtain a negative electrode slurry;
Step A6, evenly coating a surface of 6 μm PET composite copper foil with the negative electrode slurry using a coating device, wherein a coating thickness is 130-150 μm, and drying the electrode to form a pole piece;
Step A7, rolling and slicing the pole piece, wherein the roll thickness is 90-110 μm and a width of the pole piece is 72-73 mm, thus obtaining a negative pole piece.

4. The lithium-ion pouch cell with a wide temperature range and high safety according to claim 1, wherein the conductive agent comprises SuperP-Li, Ketjen black, CNT or conductive carbon black.

5. The lithium-ion pouch cell with a wide temperature range and high safety according to claim 1, wherein the water-based binder is a mixed solution of styrene-butadiene SBR emulsion and water-based polybenzoate PAA emulsion; wherein a mass ratio of styrene-butadiene SBR emulsion and water-based polyacrylate PAA emulsion is 1:1.

6. The lithium-ion pouch cell with a wide temperature range and high safety according to claim 1, wherein the preparation method for the positive pole piece comprises the following steps:
Step B1, stirring the ternary positive electrode material coated with lithium manganese iron phosphate and oily binder polyvinylidene fluoride (PVDF) with a mass ratio of (93-99):2 evenly to obtain a positive electrode slurry;
Step B2, coating the positive electrode slurry on a surface of 10 μm PET composite aluminum foil, and rolling and slicing to obtain a positive pole piece, wherein a coating thickness is 120-150 μm, a rolling thickness is 90-120 μm, and a width of the slice is 69-70 mm.

7. A preparation method for the lithium-ion pouch cell with a wide temperature range and high safety according to claim 1, wherein the preparation steps are as follows:
Step C1, winding the positive pole piece, the negative pole piece, and the polyimide nanofiber separator into a cell, and covering and pasting the core with a finishing glue;
Step C2, performing a pole ear welding the positive pole piece and the negative pole piece, wherein a length of a welding end of the pole ear welding is 12-20 mm, and a thickness of a weld toe glue of the pole ear welding is 16 μm-30 μm;
Step C3, assembling with a pre-punched pitted aluminum-plastic film and performing a top sealing and a side sealing to form an unfilled pouch cell;
Step C4, injecting electrolyte into an unfilled pouch cell to form a liquid-filled pouch cell;
Step C5, performing a standing treatment for the liquid-filled pouch cell, wherein, after the electrolyte is fully infiltrated, the formed cell is subjected to exhaust treatment and sealing to form a pouch cell;
Step C6, charging process.

8. The lithium-ion pouch cell with a wide temperature range and high safety according to claim 7, wherein a charging process comprises an activation constant-current stage, a low-voltage constant-current charging stage, and a constant voltage charging stage;
wherein the activation constant-current stage is configured to detect whether the cell state is normal and comprises initially activating the cell by charging to 3.0 V at 0.02 C;
wherein the low-voltage constant-current charging stage is configured to open and enrich a lithium-ion channel in the electrodes and separator, so as to facilitate a subsequent rapid charging of the cell, wherein the cell is charged to a cell terminal voltage of 3.45-3.65V at 0.05 C;
wherein the constant voltage charging stage is configured to promote q conversion of active substances in a deep layer of the electrode, and comprises charging the cell with constant voltage of 4.0V to 0.1 C.

9. The lithium-ion pouch cell with a wide temperature range and high safety according to claim 1, wherein the cell is functional at −50° C.-70° C.
